(19) United States
(12) Patent Application Publication
(10) Pub. No.: US 2015/0225979 A1
(43) Pub. Date: Aug. 13, 2015

(54) COMPLETELY RECESSED DOOR HANDLE PROVIDED WITH LOCK

(71) Applicant: GI.GAR S.R.L., Castelfidardo (AN) (IT)

(72) Inventor: Fernando Garofoli, Castelfidardo (AN) (IT)

(73) Assignee: GI.GAR S.R.L., Castelfidardo (AN) (IT)

(21) Appl. No.: 14/427,868

(22) PCT Filed: Sep. 23, 2013
(86) PCT No.: PCT/EP2013/069743

§ 371 Date: Mar. 12, 2015

(30) Foreign Application Priority Data
Sep. 24, 2012 (IT) AN2012A000119

(51) Int. Cl. E05B 5/00

(52) U.S. Cl. CPC E05B 5/006

(57) ABSTRACT

A handle having a box-shaped body with substantially parallelepiped shape, having suitable dimensions to be recessed in the thickness of the door in such manner that the two opposite longitudinal sides of the body are flush to the opposite sides of the door. The body houses a pair of identical holding levers with L-shaped configuration, which revolve around pivoting pins with vertical axis, both of them cooperating with a cursor composed of a plate sliding in horizontal direction and provided with a window, used to couple both holding levers, which do not protrude from said box-shaped body.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present patent application for industrial invention relates to a completely recessed door handle provided with lock.

2. Description of Related Art Including Information Disclosed Under 37 CFR 1.97 and 37 CFR 1.98.

A completely recessed door handle is a handle in which the holding lever and the support body of said holding lever do not protrude from the vertical surface of the door with unprecedented clean linear aesthetics. The models of door handles of known type comprise a bearing body wherein the locking bolt is slidingly housed, and whereon two identical holding levers of the handle are inserted from opposite sides, one on the internal side of the door, and one on the external side of the door.

In case of handles provided with door lock, said body also houses a mechanism that is normally composed of a latch actuated by means of a key.

In any case, in all models of door handles, with or without lock, the holding levers or knobs protrude from said bearing body and in any case from the two opposite vertical sides of the door, thus causing a series of drawbacks.

First of all, when the door is completely open, said protruding levers or knobs are stopped against the wall where the door is installed, with the risk of damaging the parts because of the traumatic contact.

Secondly, said holding levers or knobs can accidentally hit the body or hook the clothes of people passing near the door, who may accidentally suffer injuries or tear their clothes.

Moreover, it must be noted that the design of said door handles of known type has never reached a clean aesthetics because of the presence of said holding levers or knobs that protrude from the door.

The purpose of the present invention is to remedy the aforesaid drawbacks, by devising a completely recessed door handle provided with lock, in which the holding levers do not protrude from the two opposite sides of the door.

This purpose has been achieved by the handle of the invention, the main innovative characteristics of which are described in the first of the attached claims.

### BRIEF SUMMARY OF THE INVENTION

The door handle of the invention comprises a substantially parallelepiped box-shaped body, having suitable dimensions to be recessed in the thickness of the door, in such manner that the two opposite longitudinal sides of said body are flush to the opposite sides of the door. The body houses a pair of identical L-shaped holding levers that revolve around pivoting pins with vertical axis, both cooperating with the same cursor or latch, composed of a plate that slides in horizontal direction and is provided with a window used to couple both said L-shaped holding levers.

The holding levers do not protrude from said box-shaped body, at least until they are not pulled outwards to open the door.

The body also houses a pawl sliding inside a guide channel along a horizontal direction, orthogonal to the sliding direction of said cursor or latch; said pawl is externally provided with a catch and is constantly subject to the recoil action of a return spring that tends to eject the pawl outwards, holding it in a first end-of-travel position that corresponds to a non-working position of said catch, which is adapted to engage, in a second end-of-travel position, with a counter-catch obtained on said holding levers, in such manner to determine an interference condition that hinders the opening of the external lever of the door when the internal lever is fitted to said pawl, which has been previously pressed until it reaches said second end-of-travel position, overcoming the antagonist force of said return spring.

### BRIEF DESCRIPTION OF THE DRAWINGS

For explanatory reasons, the description of the door handle of the invention continues with reference to the attached drawings, which only have an illustrative, not limiting value, wherein:

FIGS. 1A and 1B are views of one of the two holding levers of the door handle of the invention, seen from two different angles;

FIG. 2 is an axonometric view of the handle according to the present invention;

FIGS. 3A and 3B are views of the pawl used to stop one of the two holding levers of the door handle of the invention, seen from two different angles;

FIG. 4 is a view of the latch of the handle of the invention;

FIG. 5 is a view of the handle of the invention mounted on a hinged door, seen from the internal side of the door, with the latch in maximum forward travel condition; only a portion of the entire door is shown in this figure;

FIGS. 6A and 6F are views of the various parts of the handle of the invention, in the different positions taken when the door is open, closed or closed and locked;

FIG. 7 is an exploded axonometric view of the handle mounted on the door and sectioned with a plane cutting both the door and the door frame, where the plate of said latch is fixed.

FIG. 8A is a view of the first of the two semi-bodies that form the box-shaped body of the handle according to the invention;

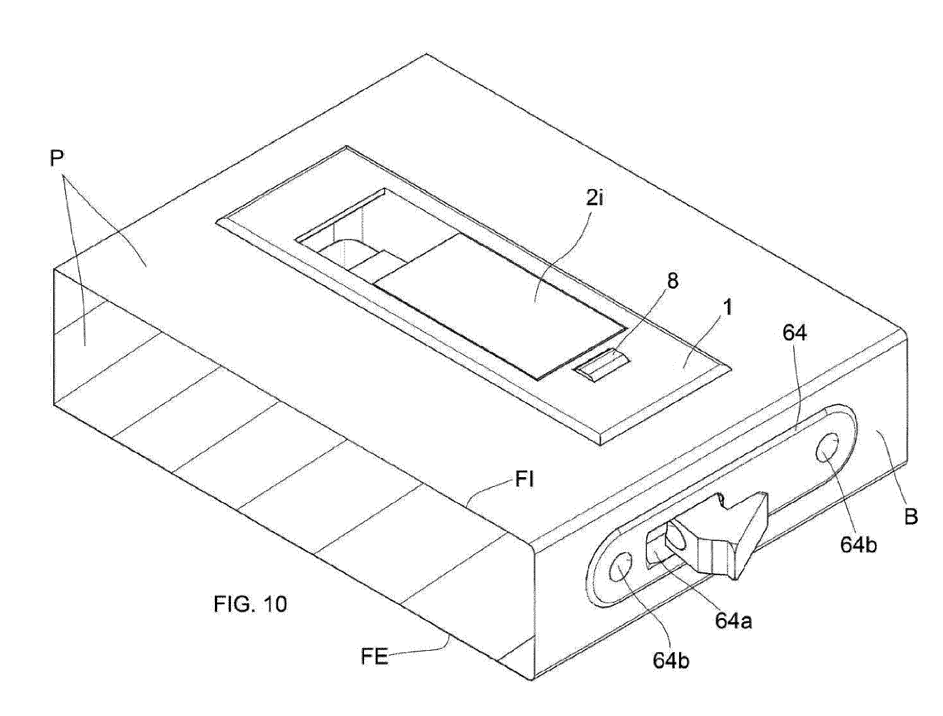

FIG. 8B is a view of the first semi-body of FIG. 8A sectioned with its longitudinal plane of symmetry;

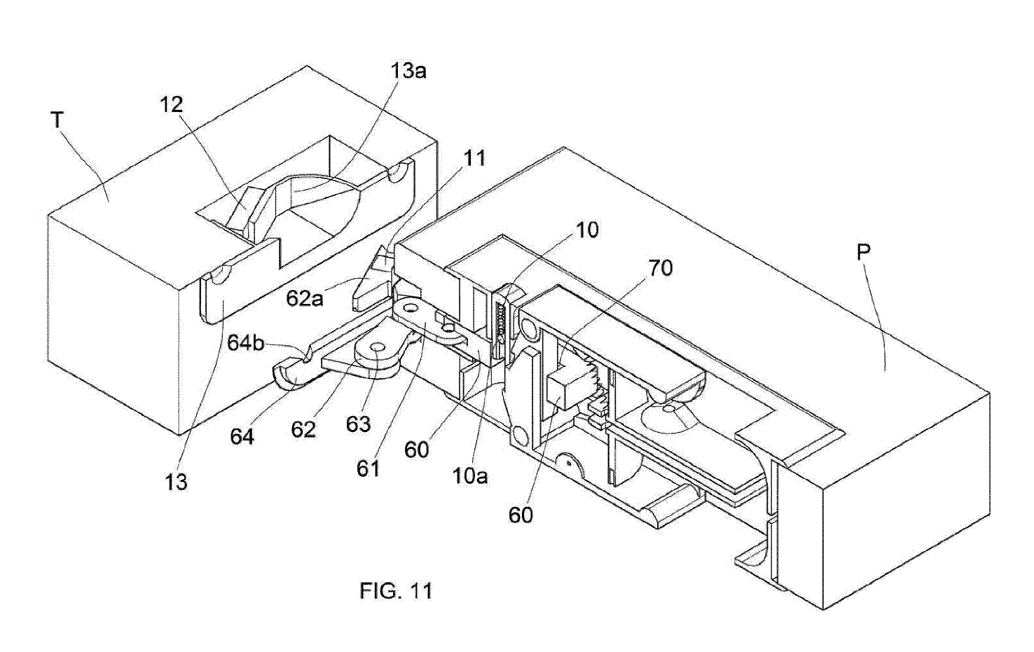

FIG. 9A is a view of the second of the two semi-bodies that form the box-shaped body of the handle according to the invention;

FIG. 9B is a view of the second semi-body of FIG. 9A sectioned with its longitudinal plane of symmetry.

### DETAILED DESCRIPTION OF THE INVENTION

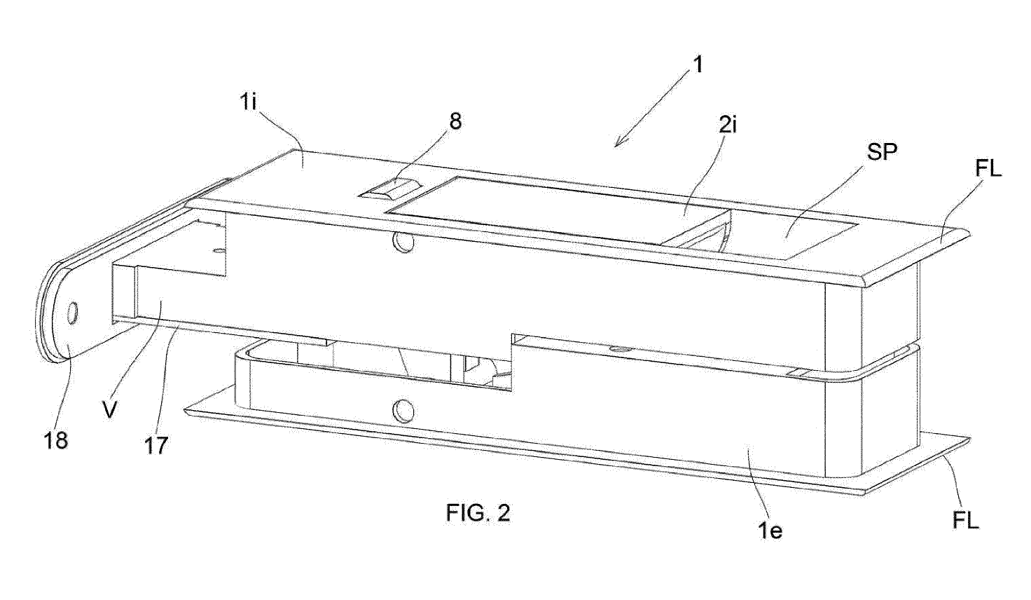

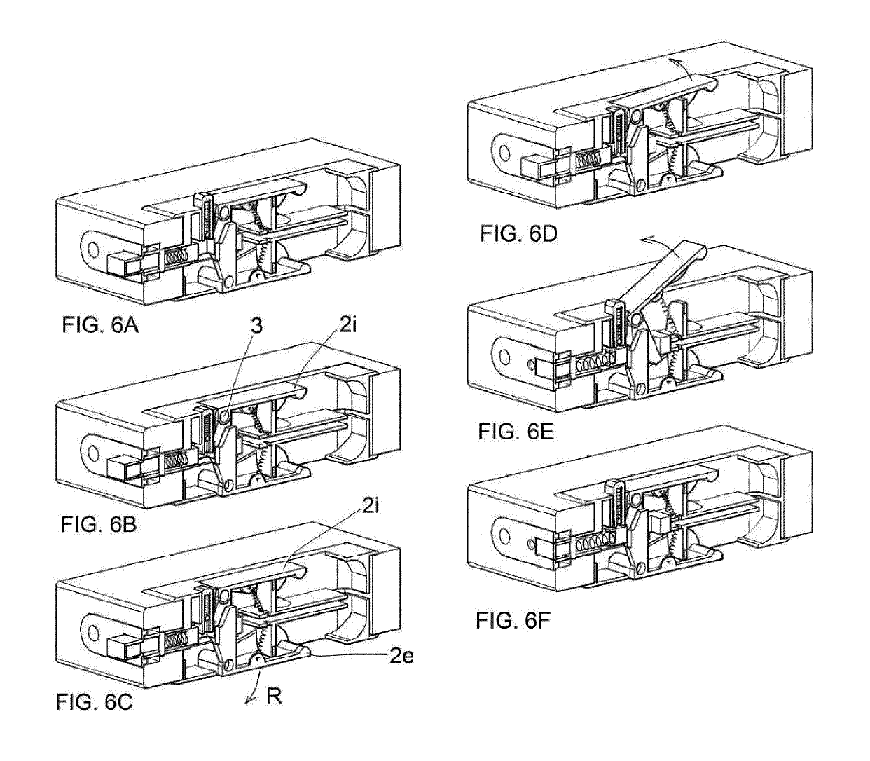

Referring to FIGS. 2 and 5, the handle of the invention comprises a box-shaped body (1) with substantially parallelepiped shape, having suitable dimensions to be recessed into the thickness (s) of the door (P), in such manner that the opposite parallel pair of longitudinal sides (FL) of said body (1) are flush to the internal side (FI) and external side (FE) of the door (P), respectively.

It is noted that said two opposite longitudinal sides (FL) are flat and lie on a vertical plane.

As shown in FIG. 2, said box-shaped body (1) is obtained by specularly coupling two almost identical semi-bodies, one (1i) facing towards the internal side (Fl) of the door, and one (1e) facing towards the external side (FE) of the door.

Each of said semi-bodies (li and 1e) acts as support for a holding lever (2), it being possible to distinguish an internal holding lever (2i) disposed on the internal side (FI) of the door and an external holding lever (2e) disposed on the external side (FE) of the door (P).

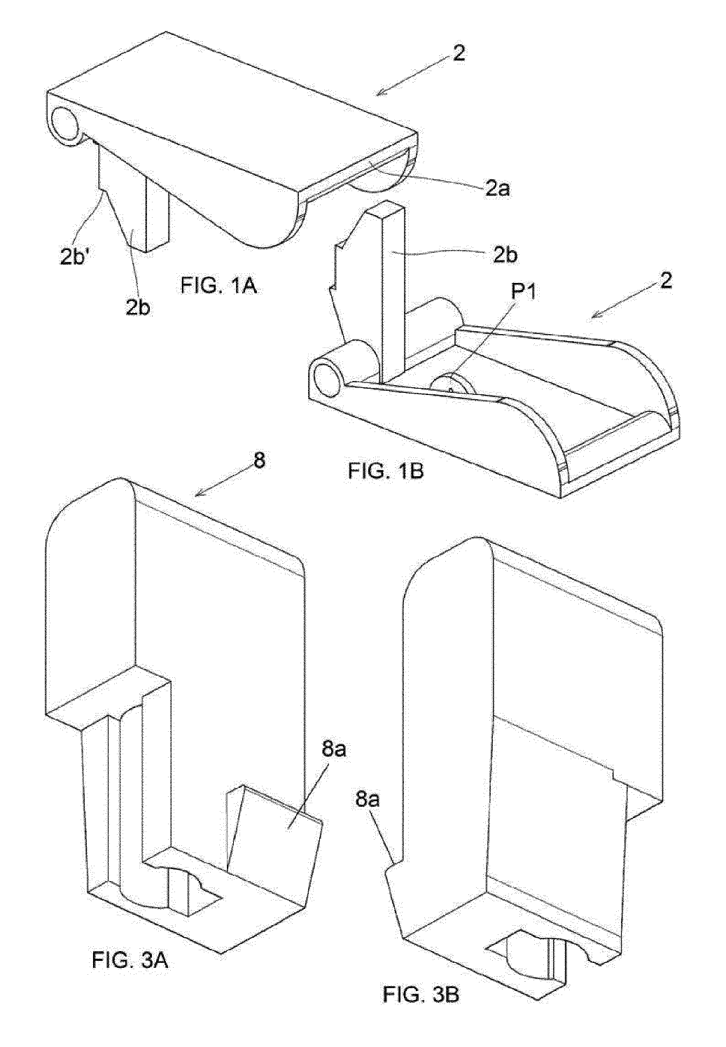

Referring to FIGS. 1A and 1B, each holding lever (2) has an L-shaped configuration, being formed of a first long arm (2a) and a second short arm (2b), orthogonal to the first arm (2a), wherein the first long arm (2a) extends—when the lever is not actuated and pulled—in parallel position flush to said opposite longitudinal sides (FL) of said body (1).

It must be noted that the two opposite longitudinal sides (FL) of the body (1) are provided with two windows (1a) that are not completely covered by said long arm (2a), thus leaving a sufficient space (SP) to insert the tip of a finger and grab the holding lever (2), rotating it outwards as shown in FIG. 5.

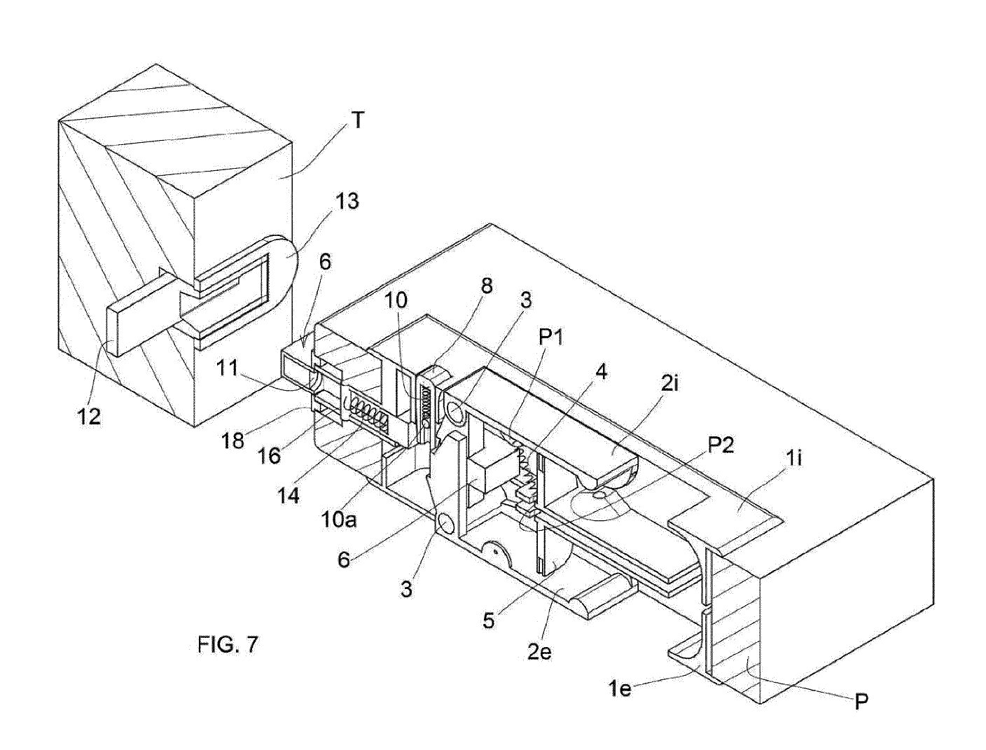

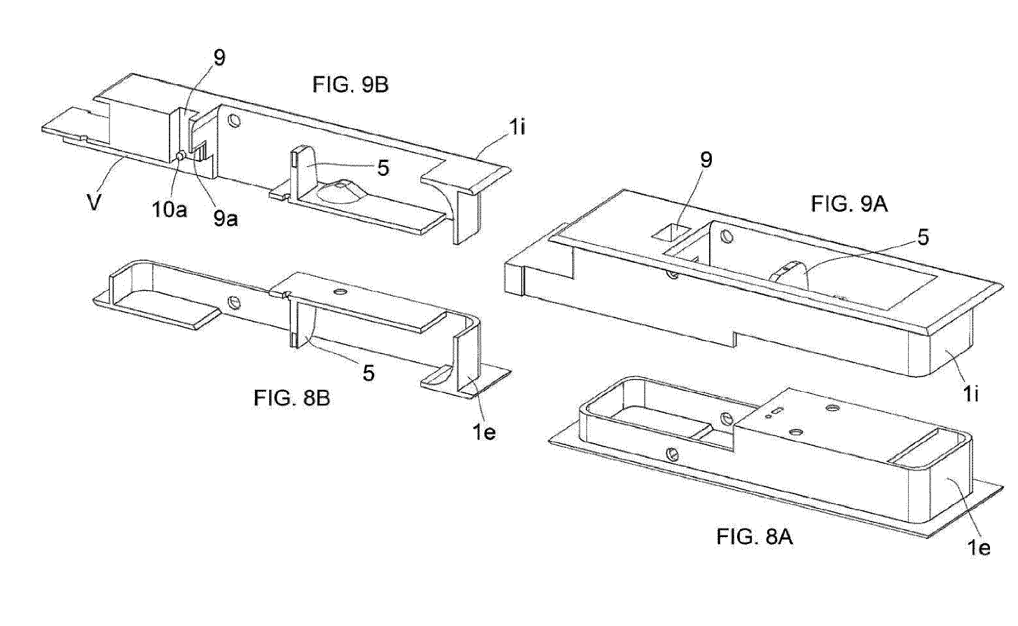

Each holding lever (2) revolves around a pivoting pin (3) with vertical axis and is subject to the recoil force of a return spring (4) fixed in a point (P1) to the long arm (2a) and in a point (P2) to the body (1), which is also provided with a partition (5) adapted to act as stop for the lever (2), which is stopped and remains stopped against said partition (5) until it is not grabbed and pulled, as shown in FIG. 6A or 7.

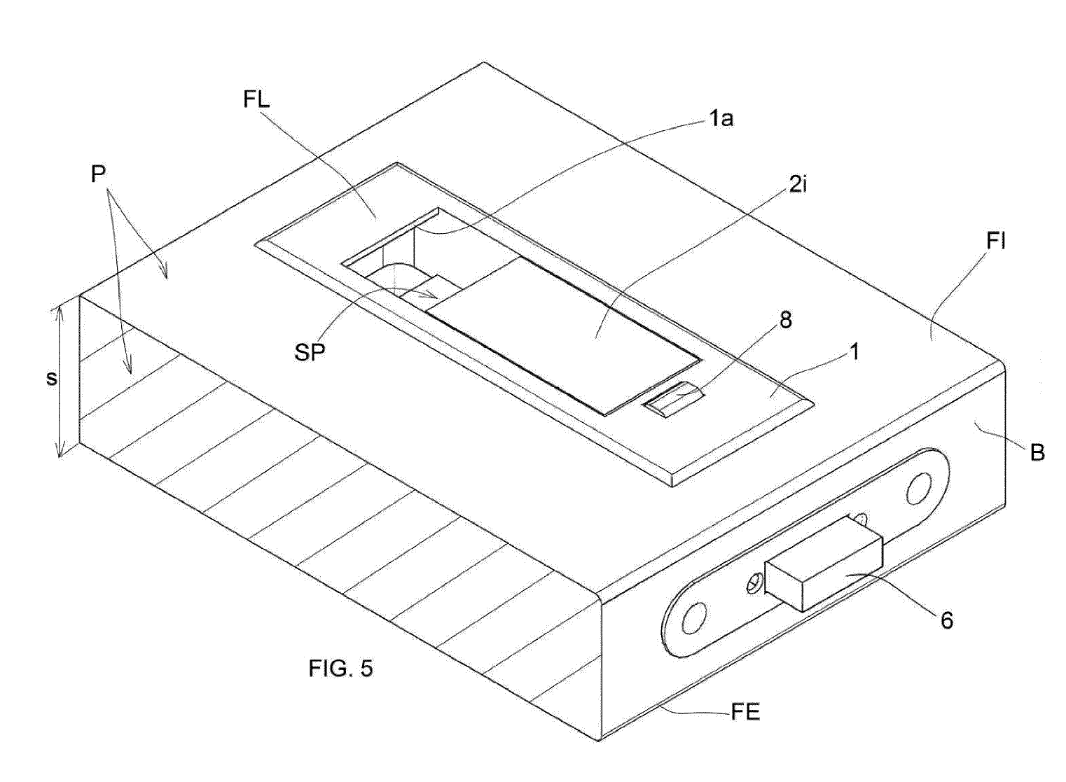

The body (1) houses a cursor (6) that slides along a horizontal axis, which acts as stop latch, composed of a rectangular plate lying on a vertical plane and provided with a large rectangular window (7) inside which both short arms (2b) of the two holding levers (2) are engaged. Referring to FIG. 4, more precisely, said cursor (6) comprises:
a front side (6a) that can have two positions: a maximum forward travel position, wherein it comes out of the rib (B) of the door (P), and a maximum backward travel position, wherein it does not come out of the rib (B) of the door (P), allowing for opening the door freely;
a back side (6b), in the proximity of which said rectangular window (7) is obtained, which remains always inside the body (1), including when the front side (6a) of the cursor (6) reaches its maximum forward travel position.

More precisely, said window (7) comprises:
a front side (7a) facing in parallel position towards said front side (6a) of the cursor (6);
a back side (7b) facing in parallel position towards said back side (6b) of the cursor (6).

The length “L” of the window (7) is such that - when the cursor (6) is in maximum forward travel condition—the back side (7b) of the window (7) is extremely close to the short side (2b) of both levers (2).

The body (1) also houses a pawl (8) that slides inside a guide channel (9) along a horizontal direction, orthogonal to the sliding direction of said cursor (6).

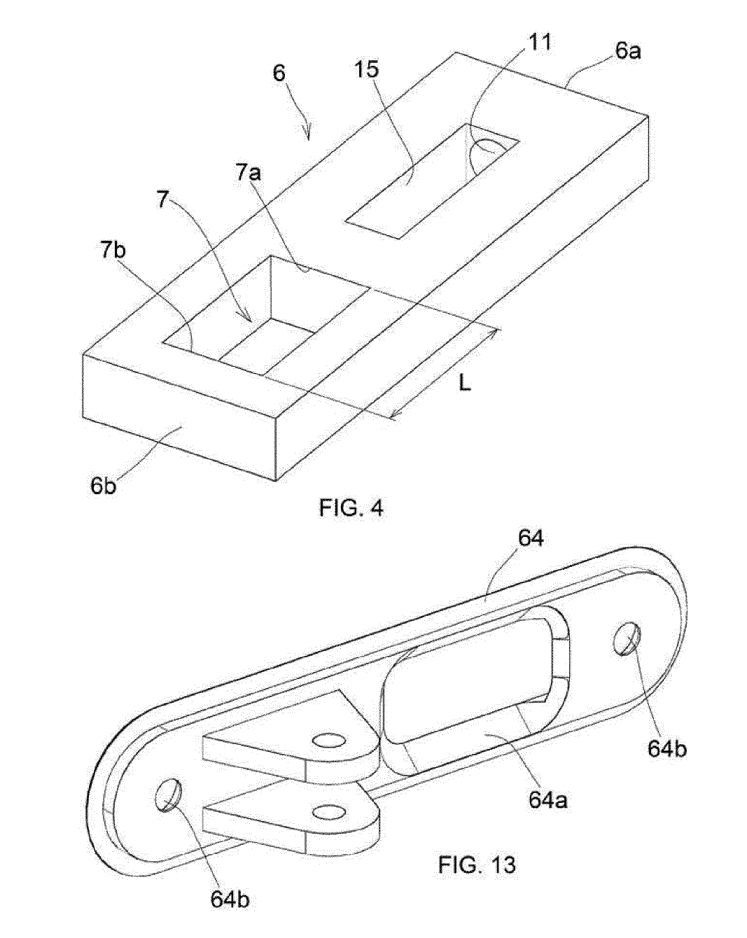

As shown in FIGS. 3A and 3B, said pawl (8) has an empty structure and is externally provided with a cuneiform catch (8a) and constantly subject to the recoil action of a return spring (10) contained inside the empty structure of the pawl.

As shown in FIGS. 1A and 1B, the short arm (2b) of each lever (2) is provided with a retention tooth (2b′) adapted to be fixed to the catch (8a) in certain conditions.

The spring (10) tends to eject the pawl (8) outwards, holding it in a first end-of-travel position (see FIG. 6F) that corresponds to the non-working position of said catch (8a) adapted to engage with said retention tooth (2b′) in a second end-of-travel position, in such manner to determine an interference condition (see FIG. 6C) that hinders the opening rotation (R) of the external lever (2e) of the door, when the internal lever (2i) is fixed to said pawl (8), which has been previously pressed until it reaches said second end-of-travel position, overcoming the antagonist force of said return spring (10), as shown in FIG. 6B.

It must be noted that in said second end-of-travel position the pawl (8) penetrates into said window (7), which is provided with suitable length “L” to permanently receive the two short arms (2b) of the two holding levers (2), as well as said pawl (8) occasionally.

As shown in sequence in FIGS. 6D and 6E, the fitting between the catch (8a) and retention tooth (2b′) is automatically eliminated when pulling the internal holding lever (2i) with consequent ejection of the pawl (8) because of the thrust of the spring (10).

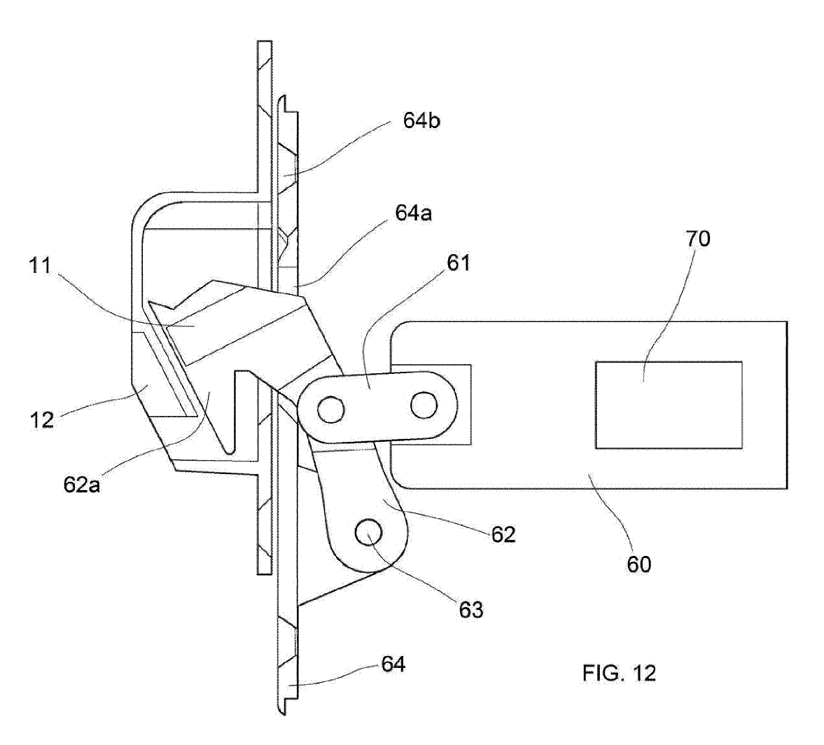

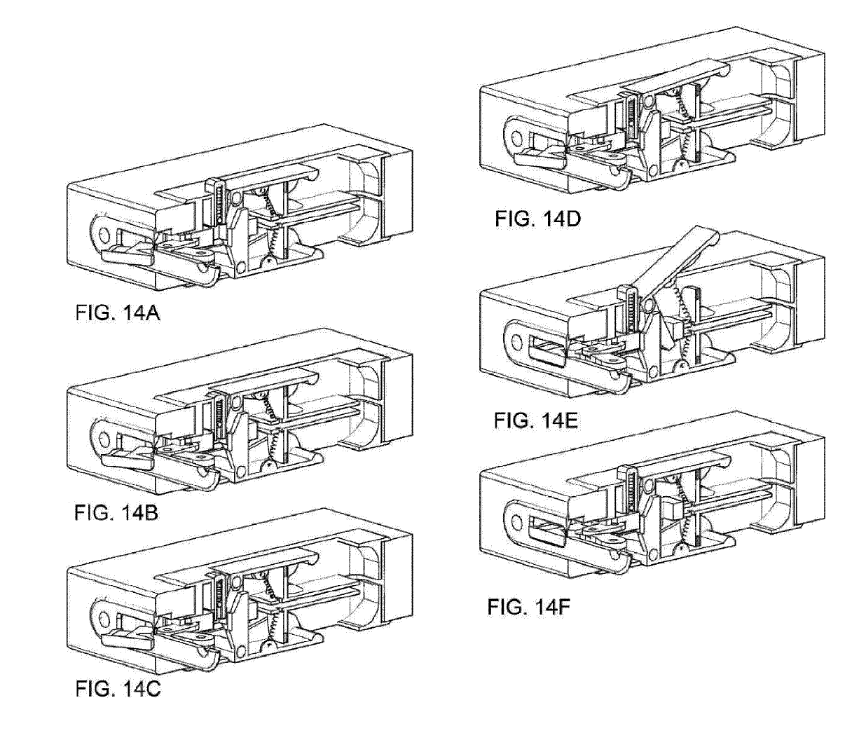

The spring (10) is disposed between the bottom of the internal cavity of the pawl (8) and a fixed peg (10a) obtained on the internal semi-body (1i), as shown in FIG. 9B.

The catch (8a) also acts as stop for the pawl (8) in maximum ejection condition under the thrust of the spring (10).

The housing and guide channel (9) of said pawl (8) is provided with a back element (9a) against which the catch (8a) is stopped at the end of the ejection travel under the thrust of the spring (10).

Referring to FIGS. 5 and 7, it must be finally noted that in correspondence of its front side (6a) the cursor (6) incorporates a magnet (11) that, when the door (P) is closed, is interfaced with an analogous magnet (12) incorporated in the back plate (13) mounted in the frame (T) of the door (P).

The presence of the pair of magnets (11 and 12) determines the automatic forward travel of the cursor (6) every time the door (P) is closed, whereas the backward travel of said cursor (6)—which is indispensable to open the door (P)—requires the manual action of one of said holding levers (2i, 2e).

As mentioned above, the pawl (8) must be pressed in order to prevent the door from being freely opened by manually actuating one of the two holding levers (2i, 2e).

Finally, it must be noted that in order to stabilize the cursor (6) in its maximum backward travel position (i.e. door open), a spring (14) is provided, the return force of which must be obviously lower than the attraction force between the magnets (11 and 12).

In particular, said return spring (14) is housed inside a second window (15) obtained on the cursor (6) near said first window (7), as shown in FIGS. 4 and 7.

The spring (14) is disposed between one of the transversal sides of the window (15) and a fixed peg (16) joined to the body (1), as shown in FIG. 7.

It must be noted that the cursor (6) is housed and slides inside a compartment (V) obtained on the internal semi-body (1i); said compartment (V) is internally closed with a rectangular plate (17), as clearly shown in FIG. 2, whereas it is frontally closed by a plate (18) provided with central slot to allow the cursor (6) to come out.

Finally, it must be noted that the door handle of the invention can be realized in two different versions, one for hinged doors, and one for sliding doors.

The previous description, as well as the aforesaid figures, refers to the version for hinged doors, whereas the following description refers to sliding doors.

It must be immediately noted that the two versions differ in a few construction details, which are indicated and described below, with reference to the following figures, wherein:

FIG. 10 is a view of said alternative version of the door handle according to the present invention, mounted on a sliding door and seen from the internal side of the door, with fastener in hooked position;

FIG. 11 is an exploded axonometric view of said alternative version of the door handle according to the present invention, mounted on the sliding door and sectioned with a plane cutting both the door and the door frame, where the plate of said fastener is fixed;

FIG. 12 is a view of the actuation mechanism of said fastener, as well as the pivoting plate of said fastener;

FIG. 13 is a view of said pivoting plate of said fastener;

FIGS. 14A to 14F are views of the various parts of the handle of the invention (in its version for sliding doors), in the different positions taken when the door is open, closed or closed and locked.

In the following description the parts of the handle that have not been modified are indicated with the same reference numbers used in the first nine figures of the hinged door version.

No modifications have been made to the holding levers (2) or pawl (8) or body of the handle, whereas the latch has been slightly modified in order to be used as simple cursor to actuate the overturning mechanism of the fastener.

Referring to FIGS. 11 and 12, the holding levers (2) are coupled with a cursor (60) provided with a window (70) where the short arms (2b) of both holding levers (2) are inserted.

The cursor (60) is connected, by means of a small connecting rod (61), to a fastener (62) that is provided at one end with a hook (62a), whereas at the other end it is provided with a hole to receive a pivoting pin (63) through which said fastener (62) is hinged to a plate (64) provided with a central slot (64a) to let said hook (62a) come out and with an opposite pair of holes (64b) for fixing on the rib (B) of the door (P).

Finally, it must be noted that said hook (62a) incorporates a magnet (11) that, when the door (P) is closed, is interfaced with an analogous magnet (12) incorporated in the back plate (13) mounted in the frame (T) of the door (P) and provided with a curved seating (13a) for hooking of said hook (62a).

1. A door handle comprising:
a box-shaped body with substantially parallelepiped shape, provided with two opposite, flat, vertical longitudinal sides;
an opposite pair of identical holding levers extending, when not actuated, in parallel position flush to said longitudinal sides of said body, said holding levers comprising an internal holding lever that can be held from the internal side of the door and an external holding lever that can be held from the external side of the door; said holding levers being pivoted on pivoting pins with vertical axis and said holding levers being subject to the return force of return springs;
a cursor slidingly housed inside said body, in a sliding direction according to a horizontal axis, and composed of a rectangular plate lying on a vertical plane and provided with a large rectangular window inside which both internal and external holding levers are fixed in such manner that the actuation of either holding lever determines a backward travel of said cursor, opening the door;
a pawl housed inside said body and sliding inside a guide channel along a horizontal direction, orthogonal to the sliding direction of said cursor.

2. The handle of claim 1, wherein said pawl has an empty structure and is externally provided with a catch and is constantly subject to the recoil action of a second return spring contained inside the empty structure of the pawl and said second return spring being adapted to eject the pawl outwards, holding it in a first end-of-travel position that corresponds to the non-working position of said catch.

3. The handle of claim 2, wherein each holding lever has an L-shaped configuration, being formed of a first long arm and a second short arm, orthogonal to the first arm, where the first long arm extends—when the holding lever is not actuated—in parallel position flush to one of said opposite longitudinal sides of said body.

4. The handle of claim 3, wherein the short arm of each holding lever is provided with a retention tooth adapted to be fixed to the catch when the pawl is pressed at the end-of-travel position towards the inside of the body.

5. The handle of claim 2, wherein said guide channel is provided with a back element, the catch being stopped against said back element at the end of the ejection travel under the thrust of the second return spring.

6. The handle of claim 3, wherein said first return spring is fixed to the long arm in a point and to the body in a point.

7. The handle of claim 6, wherein said short arms of the holding levers are inserted into said rectangular window of the cursor.

8. The handle of claim 1, wherein on the two opposite longitudinal sides of the body two windows are obtained, being not completely covered by said long arm.

9. The handle of claim 1, wherein said body comprises an opposite pair of partitions acting as stop, the two holding levers being respectively stopped and engaged against said partitions, until the holding levers are not actuated.

10. The handle of claim 1, wherein said cursor incorporates a first magnet on a front side of the cursor, when the door is closed, the first magnet is interfaced with a second magnet incorporated in a back plate mounted in a frame of the door.

11. The handle of claim 1, wherein said cursor is connected, by means of a connecting rod, to a fastener; said fastener being provided with a hook in a first end of the fastener, and said fastener being provided with a hole in a second end of the fastener; said hole of the fastener receiving a pivoting pin to hinge said fastener to a plate, said plate being provided with a central slot to let said hook of the fastener come out and said plate being provided with an opposite pair of holes for fixing on a rib of the door.

12. The handle of claim 11, wherein said hook of the fastener incorporates a first magnet, when the door is closed, said first magnet being interfaced with a second magnet incorporated in a back plate mounted in a frame of the door, said back plate provided with a curved seating for hooking of said hook.
